(19) United States
(12) Patent Application Publication
(10) Pub. No.: US 2025/0007335 A1
(43) Pub. Date: Jan. 2, 2025

(54) ROTOR, ELECTRIC MOTOR, BLOWER, VENTILATOR, ELECTRICAL MACHINE, AND AIR CONDITIONER

(71) Applicant: Mitsubishi Electric Corporation, Tokyo (JP)

(72) Inventors: Kazuhiko BABA, Tokyo (JP); Atsushi MATSUOKA, Tokyo (JP); Junichi OZAKI, Tokyo (JP)

(21) Appl. No.: 18/688,123

(22) PCT Filed: Oct. 11, 2021
(86) PCT No.: PCT/JP2021/037609

§ 371 Date: Feb. 29, 2024

(51) Int. Cl. H02K 1/02; F16C 19/08; F24F 1/20; H02K 7/08

(52) U.S. Cl. CPC H02K 1/02; F16C 19/08; F24F 1/20; H02K 7/083; F16C 2380/26; H02K 2213/03

(57) ABSTRACT

A rotor includes an outer rotor formed of a first bonded magnet, an inner rotor, and a plurality of ribs extending in a radial direction and connecting the outer rotor and the inner rotor. The first bonded magnet is a complex containing first resin and magnetic powder. Relative permittivity of the first bonded magnet is greater than 40 and equal to or less than 200.

### CROSS-REFERENCE TO RELATED APPLICATION

This application is a U.S. National Stage Application of PCT/JP2021/037609 filed Oct. 11, 2021, the contents of which are incorporated herein by reference.

### TECHNICAL FIELD

The present disclosure relates to a rotor, an electric motor, a blower, a ventilator, an electrical machine, and an air conditioner.

### BACKGROUND

There are known configurations in which the rotor of an electric motor is formed of a bonded magnet of a complex containing resin and magnetic powder. See, for example, Patent Reference 1. In Patent Reference 1, the relative permittivity of the bonded magnet is 10 or more and 40 or less. Accordingly, the capacitance between a shaft and the periphery of the bonded magnet is adjusted within the range of 3 pF to 12 pF to prevent electrolytic corrosion of a bearing supporting the shaft.

Patent Reference 1: Patent Reference 1: International Publication No. WO 2013/042282 (Paragraph 0032)

However, it was found that the relative permittivity of a bonded magnet fluctuates depending on material lots and changes over time and may be greater than 40. In this case, the capacitance between the shaft and the periphery of the bonded magnet falls outside the above range, and thus electrolytic corrosion cannot be prevented.

### SUMMARY

It is an object of the present disclosure to prevent occurrence of electrolytic corrosion regardless of variations in relative permittivity of a bonded magnet.

A rotor according to an aspect of the present disclosure includes: an outer rotor formed of a first bonded magnet, the first bonded magnet being a complex containing first resin and magnetic powder, relative permittivity of the first bonded magnet being greater than 40 and equal to or less than 200; an inner rotor; a plurality of ribs extending in a radial direction and connecting the outer rotor and the inner rotor; a shaft supporting the inner rotor; a first bearing supporting an end portion of the shaft on a load side; and a second bearing supporting an end portion of the shaft on an anti-load side, wherein the inner rotor and the plurality of ribs are formed of a second bonded magnet, and the rotor satisfies b×L1/(a×N×L2)≥0.3 and a×N/(D×π)≤0.8, where L1 is a length in an axial direction of the outer rotor, L2 is a length in the axial direction of the rib, D is a diameter of the inner rotor, N is the number of the ribs, a is a width, in a circumferential direction of the rotor, of each of the ribs, and b is a length in the radial direction of the rib.

A rotor according to another aspect of the present disclosure includes: an outer rotor formed of a first bonded magnet, the first bonded magnet being a complex containing first resin and magnetic powder, relative permittivity of the first bonded magnet being greater than 40 and equal to or less than 200; an inner rotor; a plurality of ribs extending in a radial direction and connecting the outer rotor and the inner rotor; a shaft supporting the inner rotor; a first bearing supporting an end portion of the shaft on a load side; and a second bearing supporting an end portion of the shaft on an anti-load side, wherein the inner rotor and the plurality of ribs are formed of a second resin having relative permittivity lower than relative permittivity of the first bonded magnet forming the outer rotor, the rotor satisfies b×L1/(a×N×L2)≥0.03 and a×N/(D×π)≤ 1.0, where L1 is a length in an axial direction of the outer rotor, L2 is a length in the axial direction of the rib, D is a diameter of the inner rotor, N is the number of the ribs, a is a width, in a circumferential direction of the rotor, of each of the ribs, and b is a length in the radial direction of the rib.

According to the present disclosure, occurrence of electrolytic corrosion can be prevented regardless of variations in relative permittivity of the bonded magnet.

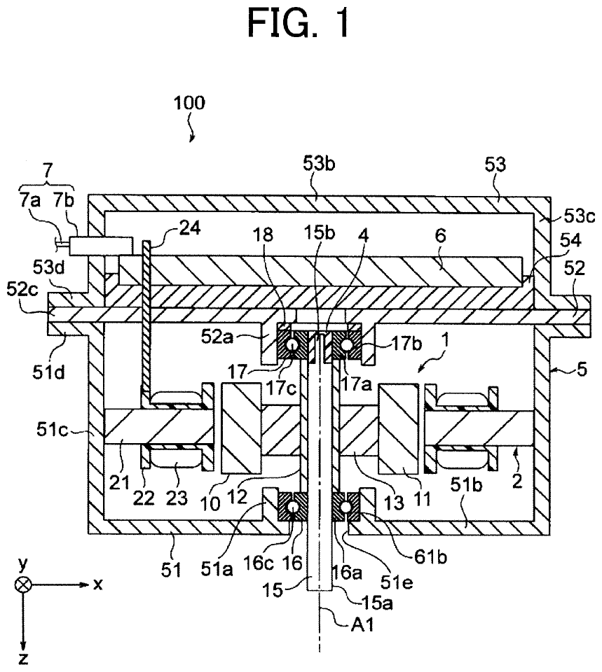

FIG. 1 is a cross-sectional view schematically showing an electric motor according to a first embodiment.

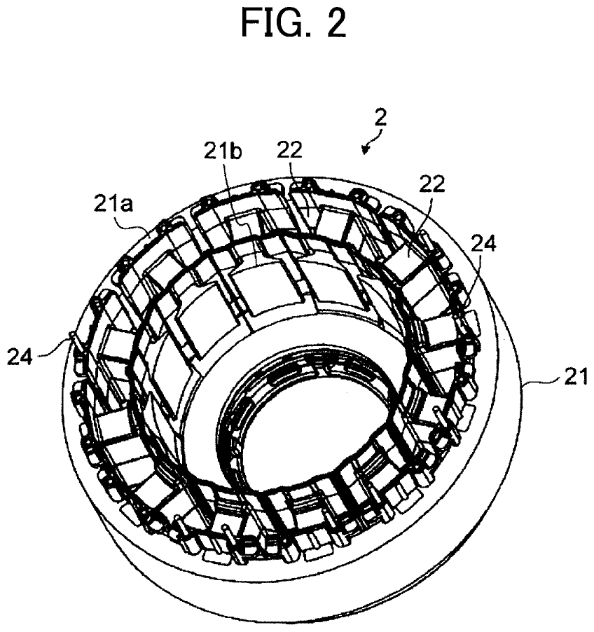

FIG. 2 is a perspective view showing the structure of a stator shown in FIG. 1.

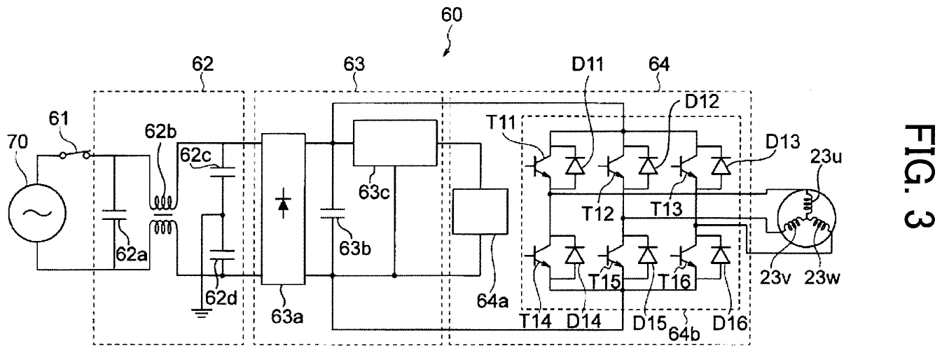

FIG. 3 is a circuit diagram showing the configuration of an electric circuit that drives the electric motor according to the first embodiment.

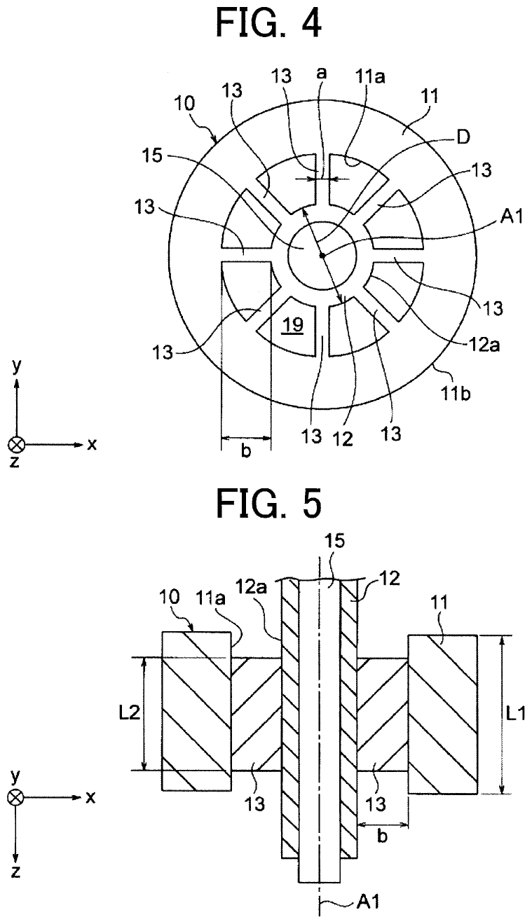

FIG. 4 is a plan view showing the configuration of a rotor according to the first embodiment.

FIG. 5 is an enlarged cross-sectional view showing a part of the configuration of the rotor shown in FIG. 1.

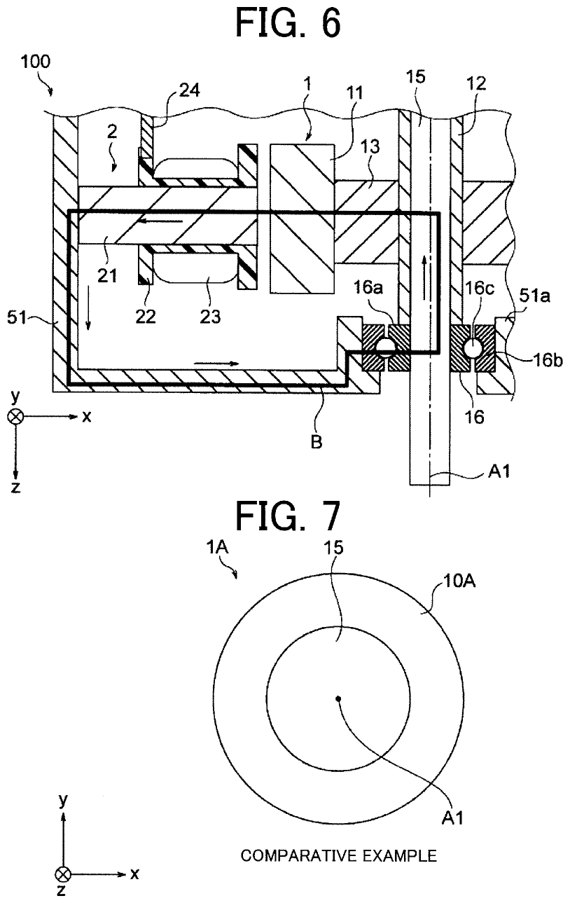

FIG. 6 is an enlarged cross-sectional view showing a part of the configuration of the electric motor shown in FIG. 1.

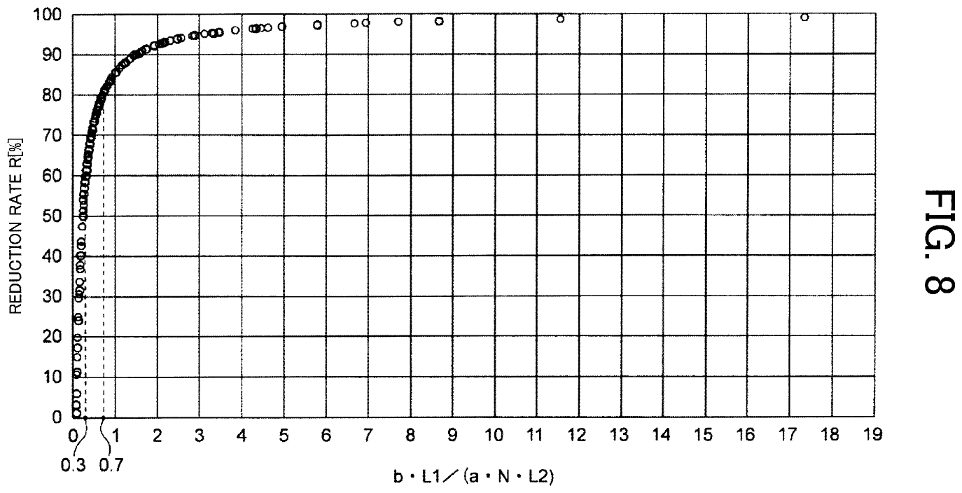

FIG. 7 is a plan view showing the configuration of a rotor according to a comparative example.

FIG. 8 is a graph showing the reduction rate of the bearing voltage in the rotor according to the first embodiment.

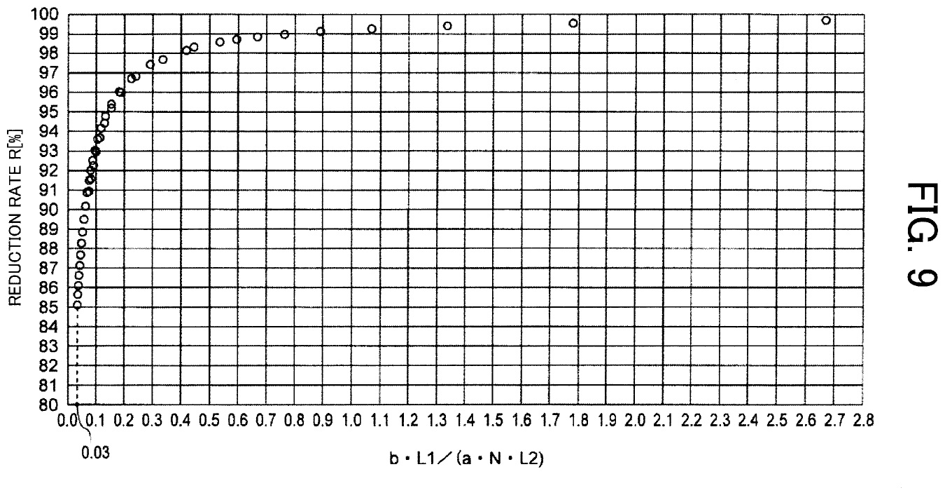

FIG. 9 is a graph showing the reduction rate of the bearing voltage in the rotor according to a second embodiment.

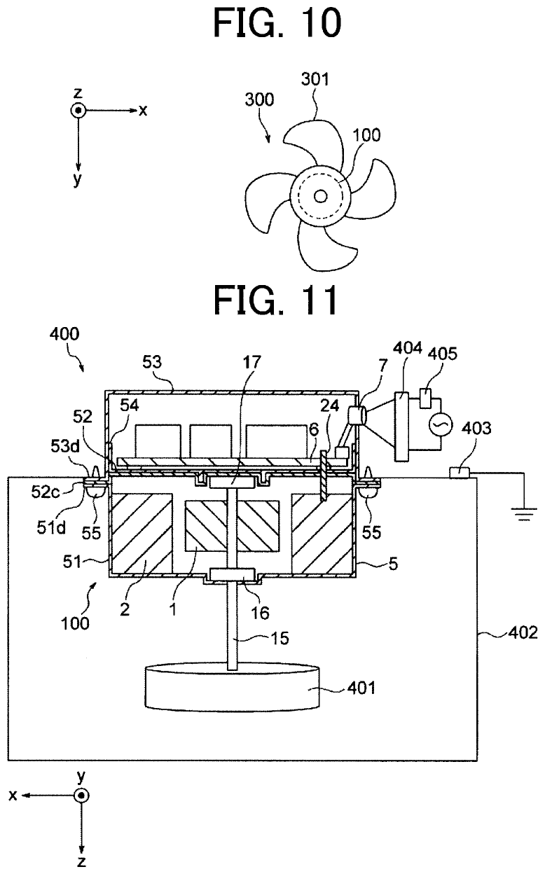

FIG. 10 is a diagram schematically showing the configuration of a blower according to a third embodiment.

FIG. 11 is a diagram schematically showing the configuration of a ventilator according to a fourth embodiment.

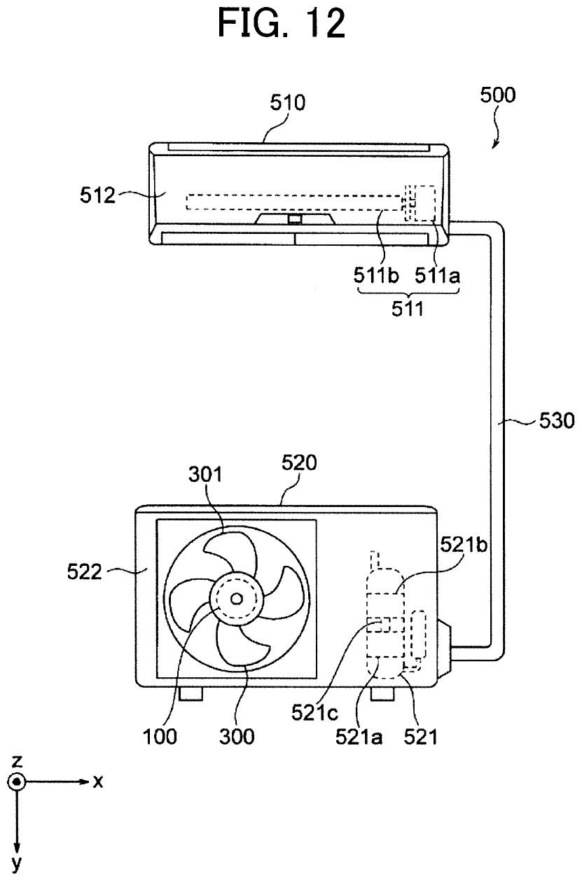

FIG. 12 is a diagram schematically showing the configuration of an air conditioner according to a fifth embodiment.

### DETAILED DESCRIPTION

A rotor, an electric motor, a blower, a ventilator, an electrical machine, and an air conditioner according to embodiments of the present disclosure will be described below with reference to the attached figures. The following embodiments are merely examples, and can be modified in various ways within the scope of the present disclosure.

To facilitate understanding of the relationship between figures, the xyz orthogonal coordinate system may be shown in the figures. The z-axis is the coordinate axis parallel to the axis A1 of a shaft 15 of a rotor 1. The x-axis is the coordinate axis orthogonal to the z-axis. The y-axis is the coordinate axis orthogonal to both the x-axis and the z-axis.

The axis A1 is the center of rotation of the rotor 1, that is, the rotation center axis of the rotor 1. It should be noted that, in the description hereafter, a direction parallel to the axis A1 is also referred to as an “axial direction of the rotor 1” or simply an “axial direction.” The xy plane is a plane perpendicular to the axial direction. Also, in the description hereafter, a “radial direction” is a radial direction of at least one of the rotor 1 or the stator 2, and a “circumferential direction” is the direction along the circumference of a circle about the axis A1 of the shaft 15. Also, the “circumferential direction” is a circumferential direction of at least one of the rotor 1 or the stator 2. Also, in the description hereafter, a “longitudinal cross section” is a cross section cut in a plane parallel to the axis A1.

### First Embodiment

### Electric Motor 100

FIG. 1 is a cross-sectional view schematically showing an electric motor 100 according to a first embodiment. As shown in FIG. 1, the electric motor 100 includes a rotor 1, a stator 2, and a conductive housing 5 as a housing. The electric motor 100 is, for example, a permanent magnet synchronous motor.

The electric motor 100 may further include a circuit board 6 and a connector 7. The circuit board 6 contains a motor drive circuit (i.e., electrical circuit 60 shown in FIG. 3 referenced later) that drives the electric motor 100.

### Stator 2

The stator 2 includes a stator core 21, an insulator 22, a coil 23, and a conductive pin 24. The coil 23 is wound around the insulator 22. The coil 23 is composed of three lead wires that conduct U-phase, V-phase, and W-phase currents. The stator 2 is press-fitted in a frame 51 of the conductive housing 5. Accordingly, the stator 2 is in mechanical contact with a side surface 51c of the conductive housing 5.

FIG. 2 is a perspective view showing the structure of the stator 2 shown in FIG. 1. In FIG. 2, the coil 23 is omitted. The stator core 21 includes a yoke 21a extending in the circumferential direction and a plurality of teeth 21b. In the first embodiment, the stator core 21 includes, for example, 12 teeth 21b. Each of the teeth 21b extends inward in the radial direction from the inner circumference of the yoke 21a. The stator core 21 is cylindrical. The stator core 21 is formed, for example, of a plurality of electrical steel sheets (not shown) laminated in the axial direction. In this case, each electrical steel sheet of the plurality of electrical steel sheets is formed into a predetermined shape with blanking. The electrical steel sheets are fixed to each other by caulking, welding, bonding, or the like.

The insulator 22 is provided on the tooth 21b. The insulator 22 is formed of, for example, a thermoplastic resin such as Poly Butylene Terephthalate (PBT). The insulator 22 electrically insulates the stator core 21 (specifically, tooth 21b) from the coil 23. The insulator 22 is unitedly molded with the stator core 21, for example. It should be noted that the pre-formed insulator 22 may be combined with the stator core 21 in the manufacturing process of the stator 2.

The conductive pin 24 is fixed to the insulator 22, for example. The conductive pin 24 electrically connects the coil 23 and the circuit board 6 (see FIG. 1). Specifically, the conductive pin 24 electrically connects the coil 23 and a switching circuit (switching circuit 64b shown in FIG. 3 referenced later) of an inverter circuit mounted on the circuit board 6. The stator 2 only has to include at least one conductive pin 24.

### Electrical Circuit 60

FIG. 3 is a circuit diagram showing the configuration of the electric circuit 60 that drives the electric motor 100 according to the first embodiment. As shown in FIG. 3, the electric circuit 60 includes a fuse 61, a filter circuit 62, a power circuit 63, and an inverter circuit 64. The electric circuit 60 is electrically connected to an AC power source 70.

When an AC voltage (e.g., a voltage in the range of 100 volts to 240 volts) from the AC power source 70 is supplied to the electric circuit 60, the AC voltage is supplied to the power circuit 63 through the fuse 61 and the filter circuit 62. The power circuit 63 converts the supplied AC voltage to DC voltage. The filter circuit 62 includes an X capacitor 62a, a common mode choke coil 62b, and Y capacitors 62c and 62d, thereby constituting a noise filter.

The power circuit 63 includes a rectifier circuit 63a, a smoothing capacitor 63b, and a switching power supply 63c. In the power circuit 63, AC voltage input through the filter circuit 62 is converted to DC voltage by full-wave rectification at the rectifier circuit 63a that includes a diode bridge. The DC voltage is accumulated in the smoothing capacitor 63b. In the smoothing capacitor 63b, the DC voltage required by the switching circuit 64b of the inverter circuit 64 (e.g., a voltage in the range from 140 volts to 280 volts) is generated. The switching power supply 63c generates control power (e.g., a DC voltage of 15 volts) required in the drive circuit 64a on the basis of the DC voltage generated in the smoothing capacitor 63b.

The inverter circuit 64 includes a drive circuit 64a and a switching circuit 64b. The drive circuit 64a generates Pulse Width Modulation (PWM) signals for turning the six switching elements T11, T12, T13, T14, T15, and T16 of the switching circuit 64b on and off.

The switching circuit 64b constitutes a three-phase bridge with a U-phase, a V-phase, and a W-phase formed between a positive bus bar and a negative bus bar. The positive bus bar is connected to the positive electrode terminal of the smoothing capacitor 63b, and the negative bus bar is connected to the negative electrode terminal of the smoothing capacitor 63b. The three switching elements T11, T12, and T13 on the positive bus bar side are upper arm transistors. The three switching elements T14, T15, and T16 on the negative bus bar side are lower arm transistors. The switching elements T11, T12, T13, T14, T15, and T16 are connected in reverse parallel to reflux diodes D11, D12, D13, D14, D15, and D16, respectively. The end connection of the switching element T11 and the switching element T14, the end connection of the switching element T12 and the switching element T15, and the end connection of the switching element T13 and the switching element T16 constitute output ends. The output ends are connected to a U-phase coil 23u, a V-phase coil 23v, and a W-phase coil 23w, respectively.

In the first embodiment, the electric motor 100 is driven through a sensor-less drive that does not use a magnetic pole position sensor such as a Hall IC. In this case, the electric motor 100 includes a magnetic pole position estimation unit (not shown) that estimates the position of the magnetic poles of the rotor 1. The magnetic pole position estimation unit estimates the position of the magnetic poles of the rotor 1 on the basis of the electric current flowing through the coil 23 (see FIG. 1) and a motor constant. The magnetic pole position estimation unit generates PWM signals for controlling electric currents supplied to the U-phase coil 23u, the V-phase coil 23v, and the W-phase coil 23w on the basis of an estimation result. Accordingly, the rotor 1 rotates.

### Rotor 1

Next, with reference to FIG. 1, the configuration of the rotor 1 will be described. The rotor 1 is disposed rotatably inside the stator 2. The rotor 1 is rotatable about the axis A1. An air gap exists between the rotor 1 and the stator 2.

The rotor 1 includes an outer rotor 11, an inner rotor 12, a plurality of ribs 13, a shaft 15 as a conductive shaft, a first bearing 16, and a second bearing 17. The outer rotor 11, the inner rotor 12, and the plurality of ribs 13 form a rotor body 10 supported on the shaft 15. The rotor body 10 is disposed between the first bearing 16 and the second bearing 17.

The shaft 15 extends in the z-axis direction. The shaft 15 is rotatably supported by the first bearing 16 and the second bearing 17. The shaft 15 is formed of a metallic material such as, for example, iron. In the example shown in FIG. 1, the end portion 15a of the shaft 15 on the load side protrudes from the conductive housing 5 to the +z-axis side, and the end portion 15b of the shaft 15 on the anti-load side does not protrude outside the conductive housing 5. It should be noted that the end portion 15b on the anti-load side of the shaft 15 may protrude from the conductive housing 5 to the −z-axis side.

The first bearing 16 is located on the load side (i.e., +z-axis side) of the electric motor 100 from the rotor body 10. The first bearing 16 rotatably supports the end portion 15a of the shaft 15 on the load side. The second bearing 17 is located on the anti-load side (i.e., −z-axis side) of the electric motor 100 from the rotor body 10. The second bearing 17 rotatably supports the end portion 15b of the shaft 15 on the anti-load side. The first bearing 16 and the second bearing 17 are, for example, deep groove ball bearings.

### First Bearing 16

The first bearing 16 that is the load side bearing includes an inner ring 16a as a first inner ring, an outer ring 16b as a first outer ring, and a plurality of balls 16c as a plurality of rolling elements. The balls 16c are disposed between the inner ring 16a and the outer ring 16b. The balls 16c have electrical conductivity. The first bearing 16 is filled with a non-conductive lubricant, and the lubricant adheres to the balls 16c. The inner ring 16a, the outer ring 16b, and the balls 16c are formed of a metallic material such as iron, for example.

The inner ring 16a is fixed to the shaft 15. The inner ring 16a is fixed to the shaft 15 with, for example, press fit or adhesive. The inner ring 16a is in contact with the shaft 15. When the inner ring 16a rotates together with the shaft 15, a thin oil film layer is formed between the raceway (i.e., outer peripheral surface) of the inner ring 16a and the balls 16c, and a thin oil film layer is formed between the raceway (i.e., inner peripheral surface) of the outer ring 16b and the balls 16c. Accordingly, the inner ring 16a and the outer ring 16b are electrically insulated from the balls 16c.

The outer diameter of the outer ring 16b and the inner diameter of a bearing housing 51a of the conductive housing 5 are substantially equal. The first bearing 16 (specifically, outer ring 16b) is fixed to the bearing housing 51a with, for example, press fit or adhesive. Accordingly, the outer ring 16b is in mechanical contact with the bearing housing 51a. It should be noted that the outer ring 16b may be disposed in the bearing housing 51a with clearance fit.

### Second Bearing 17

The second bearing 17 that is the anti-load side bearing includes an inner ring 17a as a second inner ring, an outer ring 17b as a second outer ring, and a plurality of balls 17c. The balls 17c are disposed between the inner ring 17a and the outer ring 17b. The balls 17c have electrical conductivity. The second bearing 17 is filled with a non-conductive lubricant, and the lubricant adheres to the balls 17c. The inner ring 17a, the outer ring 17b, and the balls 17c are formed of a metallic material such as iron, for example.

The inner ring 17a is fixed to an insulating sleeve 4, which is a non-conductive member, by press fit or adhesive, for example. When the inner ring 17a rotates together with the shaft 15 and the insulating sleeve 4, a thin oil film layer is formed between the raceway (i.e., outer peripheral surface) of the inner ring 17a and the balls 17c, and a thin oil film layer is formed between the raceway (i.e., inner peripheral surface) of the outer ring 17b and the balls 17c. As a result, the inner ring 17a and the outer ring 17b are electrically insulated from the balls 17c. The thickness of the oil film layer is, for example, 1.0 μm or less, but the thickness of the oil film layer varies depending on several factors, such as the rotation speed of the rotor 1 and the temperature in the electric motor 100.

The outer diameter of the outer ring 17b and the inner diameter of the bearing housing 52a of the conductive housing 5 are substantially equal. The outer ring 17b of the second bearing 17 is fixed to the bearing housing 52a with, for example, press fit or adhesive. Accordingly, the outer ring 17b is in mechanical contact with the bearing housing 52a. The outer ring 17b may be disposed in the bearing housing 52a with clearance fit.

A preload spring 18 is provided between the second bearing 17 and a bracket 52 (specifically, bearing housing 52a). The preload spring 18 provides a preload in the z-axis direction to the first bearing 16 and the second bearing 17. The preload in the z-axis direction provided to the first bearing 16 and the second bearing 17 by the preload spring 18 prevents the balls 16c and the balls 17c from rattling during the rotation of the rotor 1.

In the first embodiment, for example, deep groove ball bearings with the bearing number 608 as specified in the Japanese Industrial Standard (JIS) are used as the first bearing 16 and the second bearing 17. In the first embodiment, the size of the first bearing 16 is equal to the size of the second bearing 17. The outer diameter (i.e., diameter) of the outer ring 16b is equal to the outer diameter of the outer ring 17b. Specifically, the respective sizes of the first bearing 16 and the second bearing 17 are, for example, 22 mm in outer diameter, 8 mm in inner diameter, and 7 mm in radial width. It should be noted that the sizes of the first bearing 16 and the second bearing 17 may be different from each other.

FIG. 4 is a plan view showing the configuration of the rotor 1 according to the first embodiment. FIG. 5 is an enlarged cross-sectional view showing a part of the configuration of the rotor 1 shown in FIG. 1. As shown in FIG. 4 and FIG. 5, the outer rotor 11 is cylindrical and surrounds the inner rotor 12. The shape of the outer rotor 11 when viewed in the z-axis direction is annular. The outer rotor 11 is the outermost portion of the rotor body 10 (see FIG. 1).

The inner rotor 12 is disposed inside the outer rotor 11. The inner rotor 12 is cylindrical and is supported by the shaft 15. The inner rotor 12 is the innermost portion of the rotor body 10.

The plurality of ribs 13 connect the outer rotor 11 and the inner rotor 12. The ribs 13 extend in the radial direction from an outer circumference 12a of the inner rotor 12. The ribs 13 are aligned at equiangular gaps in the circumferential direction. A gap 19 is formed between adjacent ribs 13, in the circumferential direction, of the plurality of ribs 13. The number of ribs 13 is, for example, eight. It should be noted that the number of ribs 13 is not limited to eight, but only has to be two or more.

In the first embodiment, the outer rotor 11, the inner rotor 12, and the plurality of ribs 13 are formed from the same material, bonded magnet. Accordingly, the rotor 1 can be easily produced by injection molding. Also, it is possible to provide the rotor 1 with a small number of parts, excellent productivity, and low cost. The bonded magnet is made of a complex (composite material) containing resin (also referred to as “first resin”) and magnetic powder. Thus, the outer rotor 11, the inner rotor 12, and the plurality of ribs 13 are formed from the same material, thereby making it possible to mold integrally. In other words, the outer rotor 11, the inner rotor 12, and the plurality of ribs 13 are an integral structure. It should be noted that the inner rotor 12 and the plurality of ribs 13 may be made of a bonded magnet (referred to as a “second bonded magnet”) of a different material than a bonded magnet (referred to as a “first bonded magnet”) forming the outer rotor 11.

The outer rotor 11 has a polar anisotropic orientation due to the application of a magnetic field during molding. In the first embodiment, N poles and S poles are disposed alternately in the circumferential direction on an outer circumference 11b of the outer rotor 11. The number of poles of the rotor 1 is, for example, eight. It should be noted that the number of poles of the rotor 1 is not limited to eight poles, but only has to be two poles or more.

The resin used for the bonded magnet is a thermoplastic resin such as polyamide resin (e.g., 6PA, 12PA, PA6T, etc.) or polyphenylene sulfide (PPS) resin. When the bonded magnet contains the polyamide resin, the rotor 1 with high mechanical strength and excellent heat resistance can be obtained. Also, when the bonded magnet contains 12PA as the polyamide resin, the water absorbency can be reduced compared to a configuration in which a bonded magnet contains 6PA. In addition, when the bonded magnet contains a polyphenylene sulfide resin, the rotor 1 can be obtained with good dimensional stability in addition to having smaller water absorption and smaller relative permittivity variation.

The magnetic powder used in the bonded magnet is, for example, ferrite. For that reason, in the first embodiment, the rotor body 10 is a ferrite bonded magnet. It should be noted that the magnetic powder may be strontium ferrite (SrO-6Fe2O3) or barium ferrite (BaO-6Fe2O3).

FIG. 6 is an enlarged cross-sectional view showing a part of the configuration of the electric motor 100 shown in FIG. 1. In the electric motor 100, when the carrier frequency of the inverter circuit 64 shown in FIG. 3 is increased to compensate for a decrease in power and efficiency, etc., the current value of the discharge current (also referred to as a “shaft current”) flowing in the shaft 15 increases. In this case, the discharge current circulates, for example, in the order of the shaft 15, the rotor body 10, the stator 2, the first bearing 16 (or second bearing 17), and the shaft 15. In other words, the discharge current flows along path B shown in FIG. 6, for example. If the discharge current flows in the first bearing 16, the voltage between the inner ring 16a and the outer ring 16b (also referred to as “bearing voltage” hereafter) increases. Accordingly, corrosion, called electrolytic corrosion, may occur on the respective raceways of the inner ring 16a and the outer ring 16b, and on the rolling surfaces of the balls 16c.

In order to prevent the occurrence of electrolytic corrosion, it is contemplated to adjust the capacitance between the shaft 15 and the outer circumference 11b of the outer rotor 11. One example of a method to adjust the capacitance is to adjust the relative permittivity of the bonded magnet (in the first embodiment, a ferrite bonded magnet) that forms the outer rotor 11.

In general, the relative permittivity of resin is in the range of 3.0 to 5.0. In contrast to this, the relative permittivity of ferrite is approximately 250, which is much larger than that of resin. Until now, the characteristic distribution of the relative permittivity of ferrite bonded magnets composed of resin with a small relative permittivity and ferrite with a large relative permittivity has not been focused on, nor has it been described in a characteristics table.

Therefore, the inventor actually measured the relative permittivity of ferrite bonded magnets. Hereafter, the relative permittivity of a ferrite bonded magnet is referred to as Er. In measuring the relative permittivity Er, a dice-shaped (cube-shaped) test piece and an LCR meter were used. Specifically, aluminum foil was attached to two opposing measurement surfaces of the test piece, and the capacitance C between the two measurement surfaces was measured by an LCR meter. The measurement conditions with the LCR meter are a frequency of 16 kHz, a voltage of 1.5 V, and a temperature of 20° C.

The relative permittivity Er of the ferrite bonded magnet is calculated by the following Expression (1) using the capacitance C, etc. measured by the LCR meter.

$${ε}_{r} = C \times d / ( S \times {ε}_{0} ) \qquad ( 1 )$$

In Expression (1), d is the distance [m] between two opposing measurement surfaces of the test piece, S is the area of the measurement surface of the test piece [m²], and ε₀ is the relative permittivity of the vacuum. In the first embodiment, the relative permittivity ε₀ of the vacuum is 8.854×10⁻¹² [F/m].

The inventor extracted 32 ferrite bonded magnets with different material lots and elapsed time since ferrite bonded magnets were molded, and found that the relative permittivity Er of these ferrite bonded magnets was widely distributed in the range of values greater than 40 and equal to or less than 200. In other words, the relative permittivity Er of the ferrite bonded magnets fluctuates widely and varies widely depending on material lots and changes over time. In this case, the relative permittivity Er of the ferrite bond magnet has a large effect on the bearing voltage, and the bearing voltage increases depending on the value of the relative permittivity Er, thereby causing electrolytic corrosion in the first bearing 16 and the second bearing 17.

In the rotor 1 according to the first embodiment, even when the relative permittivity Er of the ferrite bonded magnet varies in the range of values greater than 40 and equal to or less than 200, the rotor 1 is composed of the outer rotor 11, the inner rotor 12, and a plurality of ribs 13 connecting the outer rotor 11 and the inner rotor 12, thereby making it possible to prevent the occurrence of electrolytic corrosion.

Next, the advantages of the first embodiment will be described in contrast to a comparative example. FIG. 7 is a plan view showing the configuration of a rotor 1A according to the comparative example. As shown in FIG. 7, the rotor 1A according to the comparative example has a shaft 15 and a cylindrical rotor body 10A fixed to the shaft 15. The rotor body 10A is formed of a bonded magnet. The rotor body 10A of the comparative example differs from the rotor body 10 of the first embodiment in that the rotor body 10A does not have the outer rotor 11 and the ribs 13. The outer diameter of the rotor body 10A is Φ42 mm, and the inner diameter of the rotor body 10A is Φ8 mm. The relative permittivity of the bonded magnet forming the rotor body 10A is 200.

In FIG. 4 referenced above, the number of ribs 13 is denoted by “N”, the width in the circumferential direction of the rib 13 (also referred to as a “thickness W”) is denoted by “a”, the length in the radial direction of the rib 13 (also referred to as a “length E”) is denoted by “b”, and the outer diameter of the inner rotor 12 is denoted by “D”. When the proportion of N ribs 13 in the length of the outer circumference of the inner rotor 12 is expressed as P1, the proportion P1 is expressed by the following Expression (2).

$$P 1 = a \times N / ( D \times π ) \qquad ( 2 )$$

In the first embodiment, a×N/(D×π) is equal to or less than 0.8.

Also, in FIG. 5 referenced above, the length in the z-axis direction of the outer rotor 11 is denoted by L1, and the length in the z-axis direction of the rib 13 is denoted by L2. Hereafter, the reduction rate of the bearing voltage in the rotor 1 according to the first embodiment to the rotor 1A according to the comparative example 1 (hereinafter also referred to as “reduction rate R”) will be described. In the description of the reduction rate R, the proportion P2 shown in the following Expression (3) is used. The proportion P2 is the proportion of the area of the longitudinal cross section of the gap 19 between two ribs 13 adjacent to each other in the circumferential direction of the rotor 1 (i.e., b×L1) in the total area of the longitudinal cross sections of the plurality of ribs 13 (i.e., a×N×L2).

$$P 2 = b \times L 1 / ( a \times N \times L 2 ) \qquad ( 3 )$$

FIG. 8 is a graph showing the reduction rate R of the bearing voltage in the rotor 1 according to the first embodiment. In FIG. 8, the horizontal axis shows the proportion P2=b×L1/(a×N×L2). The vertical axis shows the reduction rate R. The larger the reduction rate R, the smaller the bearing voltage in the first bearing 16 and the second bearing 17. When the reduction rate R is 100%, the bearing voltage is 0 V.

As shown in FIG. 8, in the range of the reduction rate R from 0% to 60%, the reduction rate R changes linearly as the proportion P2 increases, and the reduction rate R changes more slowly when the reduction rate R is equal to or greater than 60%. When the reduction rate R is 60%, the proportion P2 is 0.3. Therefore, when the proportion P2 is set to 0.3 or more, the bearing voltage is reduced, and thus electrolytic corrosion is less likely to occur in the first bearing 16 and the second bearing 17. Therefore, the life of the first bearing 16 and the second bearing 17 can be extended.

In order to further prevent the occurrence of electrolytic corrosion, it is preferable that the reduction rate R of the bearing voltage be equal to or greater than 80%. In the example shown in FIG. 8, the proportion P2 is 0.7 for situations where the reduction rate R is 80%. Therefore, when the proportion P2 is set to 0.7 or more, the bearing voltage can be reduced, and thus the life of the first bearing 16 and the second bearing 17 can be further extended. In the first embodiment, when the following equations (4) and (5) are satisfied, the occurrence of the electrolytic corrosion in the first bearing 16 and the second bearing 17 can be prevented.

$$b \times L 1 / ( a \times N \times L 2 ) \geq 0.7 \qquad ( 4 )$$

$$a \times N / ( D \times π ) \leq 0.8 \qquad ( 5 )$$

Also, in the first embodiment, as shown in FIG. 1, the outer diameter of the end portion 15b of the shaft 15 on the anti-load side is smaller than the outer diameter of the other part of the shaft 15 (e.g., the end portion 15a on the load side). The end portion 15b of the shaft 15 on the anti-load side is covered by the insulating sleeve 4. Accordingly, the discharge current that flows into the second bearing 17 on the anti-load side can be reduced. Therefore, the occurrence of the electrolytic corrosion in the second bearing 17 can be reduced. It should be noted that the insulating sleeve 4 may cover the end portion 15a of the shaft 15 on the load side.

### Conductive Housing 5

Next, the configuration of the conductive housing 5 will be described with reference to FIG. 1. The conductive housing 5 houses the rotor 1 and the stator 2. The conductive housing 5 is made of a metallic material such as iron, for example. The conductive housing 5 includes the frame 51 and the bracket 52.

The frame 51 has electrical conductivity. The frame 51 is, for example, a cup-shaped frame. The rotor 1 and the stator 2 are disposed in the frame 51. The frame 51 is mechanically or electrically connected to the periphery of the stator 2. Accordingly, the stator 2 is grounded. The frame 51 includes a bearing housing 51a in which the first bearing 16 is held. The bearing housing 51a protrudes from a bottom plate 51b of the frame 51 to the −z-axis side. Also, the frame 51 includes a through hole 51e through which the shaft 15 passes.

The bracket 52 has electrical conductivity. The bracket 52 is formed of a metallic material such as iron, for example. The bracket 52 includes a bearing housing 52a. The bearing housing 52a protrudes from the bottom of the bracket 52 to the +z-axis side. The bearing housing 52a holds the second bearing 17. In the example shown in FIG. 1, the outer ring 17b of the second bearing 17 is in contact with the bearing housing 52a.

The conductive housing 5 may further include a circuit cover 53. The circuit cover 53 is formed of a conductive material. The circuit cover 53 is formed of a metallic material such as iron, for example. The circuit cover 53 covers at least the circuit board 6. Specifically, the circuit cover 53 covers the circuit board 6 and the bracket 52. It should be noted that, in the first embodiment, the circuit board 6 is disposed inside the conductive housing 5, but part or all of the circuit board 6 may be disposed outside the conductive housing 5. Also, the circuit cover 53 may be formed of a resin material.

The bracket 52 described above is disposed between the frame 51 and the circuit cover 53. Accordingly, the interior space of the electric motor 100 is divided into a motor housing section in which the rotor 1 and the stator 2 are disposed and a circuit housing section in which the circuit board 6 is disposed.

The conductive housing 5 may further include a circuit case 54 that fixes the circuit board 6. The circuit case 54 is disposed within the circuit cover 53. The circuit case 54 is fixed to the bracket 52, for example. The circuit case 54 is formed of a non-conductive material. The circuit case 54 is formed of a non-conductive resin material, for example. The circuit case 54 includes a recess to which the circuit board 6 is fixed, the recess is formed by, for example, a press molding process.

The frame 51, the bracket 52, and the circuit cover 53 include flanges 51d, 52c, and 53d, respectively. The flanges 51d, 52c, and 53d are fixed to each other, for example, by screws (not shown). The frame 51, the bracket 52, and the circuit cover 53 are mechanically connected and electrically connected to each other. It should be noted that at least the frame 51 and the bracket 52 of the frame 51, the bracket 52, and the circuit cover 53 only have to be electrically connected. By mechanically and electrically connecting the frame 51 and bracket 52 in this way, the outer ring 16b of the first bearing 16 and the outer ring 17b of the second bearing 17 can be made equipotential with a simple configuration, thereby reducing the bearing voltage.

Although the first embodiment describes an example in which the frame 51 and the bracket 52 are formed of conductive material, the example is not limited to this. One or both of the frame 51 and the bracket 52 may be formed of non-conductive material. When either the frame 51 or the bracket 52 is formed of conductive material and the other is formed of non-conductive material, the non-conductive member is disposed between the inner ring of the bearing held by the conductive material and the shaft, and thus the bearing voltage can be reduced. When the non-conductive member is formed of a resin material (e.g., unsaturated polyester resin such as Bulk Molding Compound: BMC), mechanical strength and dimensional accuracy can be improved.

### Connector 7

The connector 7 is fixed to the circuit cover 53. The connector 7 includes, for example, wiring 7a and a non-conductive cover 7b that covers the wiring 7a. The wiring 7a is connected to the circuit board 6.

### Advantages of First Embodiment

According to the first embodiment described above, the rotor 1 includes the outer rotor 11 made of a bonded magnet whose relative permittivity is greater than 40 and equal to or less than 200, the inner rotor 12, and the plurality of ribs 13 extending in the radial direction connecting the outer rotor 11 and the inner rotor 12. Accordingly, the increase in bearing voltage is suppressed even when the relative permittivity of the portion of the bonded magnet forming the outer rotor 11 fluctuates significantly due to differences in material lots and changes over time. Therefore, the occurrence of the electrolytic corrosion in the first bearing 16 and the second bearing 17 can be prevented.

Also, according to the first embodiment, b×L1/(a×N×L2) is equal to or greater than 0.7 and a×N/(D×π) is equal to or less than 0.8, where “N” is the number of ribs 13, “a” is the thickness in the circumferential direction of the rib 13, “b” is the length in the radial direction of the rib 13, “L1” is the length in the z-axis direction of the outer rotor 11, and “L2” is the length in the z-axis direction of the rib 13. Accordingly, the reduction rate R of the bearing voltage can be 80% or more. Therefore, the increase in bearing voltage is suppressed, and thus the occurrence of the electrolytic corrosion in the first bearing 16 and the second bearing 17 can be prevented.

Also, according to the first embodiment, the inner rotor 12 and the plurality of ribs 13 are made of a bonded magnet of the same material as a bonded magnet forming the outer rotor 11. Accordingly, the rotor 1 can be easily produced by injection molding. In addition, it is possible to provide the rotor 1 with a small number of parts, excellent productivity, and low cost.

Also, according to the first embodiment, the magnetic powder of the bonded magnet is ferrite. This makes it possible to achieve the rotor 1 that is inexpensive and easy to obtain materials.

Also, according to the first embodiment, the resin of the bonded magnet contains at least one of polyamide resin or polyphenylene sulfide resin. When the resin of the bonded magnet contains the polyamide resin, the rotor 1 with high mechanical strength and good heat resistance can be achieved. Also, when the bonded magnet contains the polyphenylene sulfide resin, the rotor 1 with low water absorption and good dimensional stability can be achieved. Also, when the bonded magnet contains the polyphenylene sulfide resin, the variation in relative permittivity of the bonded magnet can be reduced.

Also, according to the first embodiment, the outer rotor 11, the inner rotor 12, and the ribs 13 are formed of the same bonded magnet. Accordingly, the rotor 1 can be easily formed by injection molding. Also, it is possible to achieve the rotor 1 with a small number of parts, excellent productivity, and low cost.

Also, according to the first embodiment, the electric motor 100 includes the rotor 1. In the rotor 1, the occurrence of the electrolytic corrosion in the first bearing 16 and the second bearing 17 is prevented, thereby reducing vibration and noise in the electric motor 100.

Also, according to the first embodiment, the electric motor 100 includes the conductive housing 5 that houses the rotor 1 and the stator 2. The outer circumference of the stator 2 is in electrical contact with the side surface 51c of the conductive housing 5. The outer ring 16b of the first bearing 16 and the outer ring 17b of the second bearing 17 are in electrical contact with the bearing housings 51a and 52a of the conductive housing 5 respectively. Accordingly, the first bearing 16 and the second bearing 17 can be made equipotential with a simple configuration, thereby reducing the bearing voltage.

### Second Embodiment

Next, a rotor according to the second embodiment will be described. In the first embodiment described above, the inner rotor 12 and the plurality of ribs 13 are formed of the same bonded magnet as the outer rotor 11. The rotor according to the second embodiment differs from the rotor 1 according to the first embodiment in that the inner rotor 12 and the plurality of ribs 13 are formed of a resin material. Other than this, the rotor according to the second embodiment is the same as the rotor 1 according to the first embodiment. For that reason, the following description refers to FIG. 4.

The rotor according to the second embodiment includes the outer rotor 11, the inner rotor 12, and the plurality of ribs 13 (see FIG. 4). The inner rotor 12 and the plurality of ribs 13 are formed of a resin material (also referred to as a “second resin”) having a relative permittivity lower than a relative permittivity of the bonded magnet forming the outer rotor 11. The inner rotor 12 and the plurality of ribs 13 are formed of thermoplastic resin such as PBT, PPS, Liquid Crystal Plastic (LCP) resin, Poly Propylene (PP), Acrylonitrile Butadiene Styrene (ABS) resin, and Poly Amide (PA), or thermoplastic resin such as unsaturated polyester resin, epoxy resin, phenolic resin, or the like.

FIG. 9 is a graph showing the reduction rate R of the bearing voltage in the rotor according to the second embodiment. In FIG. 9, the horizontal axis shows the proportion P2=b×L1/(a×N×L2), and the vertical axis shows the reduction rate R of the bearing voltage of the rotor according to the second embodiment to the rotor 1A according to the comparative example (see FIG. 7). As shown in FIG. 9, the larger the value of the proportion P2, the larger the reduction rate R. In the example shown in FIG. 9, the change in reduction rate R becomes gradually smaller when b×L1/(a×N×L2) is greater than or equal to 0.2.

Also, in the example shown in FIG. 9, when b×L1/(a×N×L2) is greater than or equal to 0.03, the reduction rate R can be greater than or equal to 858. Also, in the second embodiment, a×N/(D×π) is smaller than or equal to 1.0. In other words, in the second embodiment, the reduction rate of the bearing voltage can be 85% or more by satisfying the following expressions (6) and (7).

$$b \times L 1 / ( a \times N \times L 2 ) \geq 0.03 \qquad ( 6 )$$

$$a \times N / ( D \times π ) \leq 1.0 \qquad ( 7 )$$

In the first embodiment described above, the reduction rate R can be greater than or equal to 80% by setting b×L1/(a×N×L2) to greater than or equal to 0.7. For that reason, in the second embodiment, the bearing voltage can be further reduced because the reduction rate R can be greater than or equal to 85% by satisfying the expressions (4) and (5) described above.

### Advantages of Second Embodiment

According to the second embodiment described above, the inner rotor 12 and the plurality of ribs 13 are formed of a resin material having a relative permittivity lower than a relative permittivity of the bonded magnet forming the outer rotor 11. Accordingly, even when the relative permittivity of the bonded magnet is greater than 40, the increase in bearing voltage in the first bearing 16 and the second bearing 17 can be suppressed, and thus the occurrence of electrolytic corrosion in the first bearing 16 and the second bearing 17 can be prevented. Therefore, vibration and noise in the electric motor according to the second embodiment can be reduced.

Also, according to the second embodiment, b×L1/(a×N×L2) is greater than or equal to 0.03 and a×N/(D×π) is smaller than or equal to 1.0, where “N” is the number of ribs 13, “a” is the thickness in the circumferential direction of the rib 13, “b” is the length in the radial direction of the rib 13, “L1” is the length in the z-axis direction of the outer rotor 11, and “L2” is the length in the z-axis direction of the rib 13. Accordingly, the second embodiment allows the reduction rate R of the bearing voltage to be greater than or equal to 80%. Therefore, the increase in bearing voltage is suppressed and consequently the occurrence of the electrolytic corrosion in the first bearing 16 and the second bearing 17 can be prevented.

### Third Embodiment

Next, the configuration of the blower 300 according to a third embodiment will be described. FIG. 10 is a diagram schematically showing the configuration of the blower 300 according to the third embodiment.

As shown in FIG. 10, the blower 300 includes the electric motor 100 and a blade 301 driven by the electric motor 100. The blade 301 is a load attached to the shaft 15 of the electric motor 100 (see, for example, FIG. 1). Rotation of the shaft 15 of the electric motor 100 causes the blade 301 to rotate and generate airflow. The blower 300 is used, for example, as an outdoor blower 520b of an outdoor unit 520 of an air conditioner 500 shown in FIG. 12 referenced later. In this case, the blade 301 is, for example, propeller fan. In other words, the electric motor 100 can be used as a fan motor.

### Advantages of Third Embodiment

According to the third embodiment described above, the blower 300 includes the electric motor 100 according to the first or second embodiment. As described above, the electric motor 100 can suppress the increase in vibration and noise by preventing the occurrence of electrolytic corrosion. Thus, the increase in vibration and noise in the blower 300 can be suppressed. Therefore, a highly reliable blower 300 can be provided.

### Fourth Embodiment

Next, the configuration of a ventilator 400 according to a fourth embodiment will be described. FIG. 11 is a diagram schematically showing the configuration of the ventilator 400 according to the fourth embodiment. The ventilator 400 is used for a wide range of applications, including residential and commercial use. The ventilator 400 is used, for example, in residential living rooms, kitchens, bathrooms, toilets, or the like.

The ventilator 400 includes the electric motor 100 and a blade 401 driven by the electric motor 100. The blade 401 is fixed to the end on the load side of the shaft 15 of the electric motor 100.

At least the blade 401 and a part of the electric motor 100 are covered by a ventilator body 402. The conductive housing 5 of the electric motor 100 is fixed to the ventilator body 402 with screws 55. The ventilator body 402 includes a power connection terminal block 404 and a ground connection terminal 403.

The connector 7 of the electric motor 100 is connected to the power connection terminal block 404. One of the external connection terminals of the power connection terminal block 404 is connected to one end of a power line of an AC power supply through the switch 405, and the other end of the external connection terminals of the power connection terminal block 404 is directly connected to the other end of the power line of the AC power supply. That is, the supply of power to the electric motor 100 is controlled by turning the switch 405 on and off. When the switch 405 is turned on, power is supplied to the electric motor 100, the blade 401 fixed to the shaft 15 of the electric motor 100 rotate to ventilate the room.

When the ventilator 400 includes the electric motor 100 according to the first or second embodiment, the performance of the ventilator 400 can be maintained over a long period of time. Also, when the ventilator 400 includes the electric motor 100 according to the first of second embodiment, the increase of vibration and noise in the ventilator 400 can be suppressed.

The flanges 51d, 52c, and 53d of the conductive housing 5 are fixed to the ventilator body 402 of the ventilator 400 with screws 55. The frame 51 of the electric motor 100 is disposed inside the ventilator body 402. The circuit board 6 of the electric motor 100 is disposed outside the ventilator body 402. The bracket 52 is disposed between the circuit board 6 and the rotor 1. Accordingly, since the circuit board 6 is isolated from the rotor 1, the circuit board 6 is less susceptible to the temperature and humidity of the inside of the ventilator body 402. Thus, stable performance of the ventilator 400 can be maintained for a long period of time. Therefore, the increase of vibration and noise in the ventilator 400 can be suppressed and consequently a comfortable space can be provided for a long period of time.

Also, when the conductive housing 5 of the electric motor 100 is made of metal material, the strength of the electric motor 100 for holding the rotor 1 is increased. Therefore, when the conductive housing 5 of the electric motor 100 is a metal housing, a heavier blade, such as a large blade and a metal blade, can be applied to the blade 401.

### Advantages of Fourth Embodiment

According to the fourth embodiment described above, the ventilator 400 includes the electric motor 100 according to the first or second embodiment. Since the generation of electrolytic corrosion is prevented in the electric motor 100 described above, and thus the increase in vibration and noise can be suppressed. Accordingly, vibration and noise in the ventilator 400 can be reduced.

### Fifth Embodiment

Next, the configuration of an air conditioner 500 according to embodiment 5, which is an example of an electrical machine in which the electric motor 100 according to the first of second embodiment is mounted, will be described. FIG. 12 is a diagram schematically showing the configuration of the air conditioner 500 according to the fifth embodiment.

As shown in FIG. 12, the air conditioner 500 includes an indoor unit 510 and an outdoor unit 520 to be connected to the indoor unit 510. The indoor unit 510 and the outdoor unit 520 are connected through refrigerant piping 530 to form a refrigerant circuit in which a refrigerant circulates. The air conditioner 500 is capable of performing a cooling operation of sending cold air from the indoor unit 510, and a heating operation of sending hot air, for example.

The indoor unit 510 includes an indoor blower 511 and a housing 512 that houses the indoor blower 511. The indoor blower 511 includes an electric motor 511a and a blade 511b driven by the electric motor 511a. The blade 511b are attached to the shaft of the electric motor 511a. Rotation of the shaft of the electric motor 511a causes the blade 511b to rotate and generate airflow. The blade 511b is, for example, a cross flow fan.

The outdoor unit 520 includes a blower 300 as an outdoor blower, a compressor 521, and a housing 522 that houses the blower 300 and the compressor 521. The compressor 521 includes a compression mechanism 521a that compresses refrigerant and an electric motor 521b that drives the compression mechanism 521a. The compression mechanism 521a and the electric motor 521b are connected to each other by a rotation shaft 521c.

For example, during the cooling operation of the air conditioner 500, the heat released when the refrigerant compressed by the compressor 521 condenses in a condenser (not shown) is released outside a room by the airflow of the blower 300. The outdoor unit 520 further includes a four-way valve (not shown) that switches the flow direction of the refrigerant. The four-way valve of the outdoor unit 520 allows high temperature and pressure refrigerant gas delivered from the compressor 521 to flow to the heat exchanger of the outdoor unit 520 during the cooling operation and to the heat exchanger of the indoor unit 510 during the heating operation. It should be noted that the electric motor 100 according to the first or second embodiment is not limited to the air conditioner 500, but may be included in other equipment. Specifically, the electric motor 100 can be installed in other home appliances and machine tools, except for the ventilator 400 described in the fourth embodiment and the air conditioner 500. Also, the electric motor 100 can be installed in other electrical machines such as electric vehicles, drones, and robots.

### Advantages of Fifth Embodiment

According to the fifth embodiment described above, the outdoor unit 520 of the air conditioner 500 includes the electric motor 100 according to the first or second embodiment. As described above, since the increase of the vibration and noise in the electric motor 100 according to the first or second embodiment is suppressed and thus the increase of the vibration and noise in the air conditioner 500 can be suppressed. Therefore, a highly reliable air conditioner can be provided.

1. A rotor comprising:
an outer rotor formed of a first bonded magnet, the first bonded magnet being a complex containing first resin and magnetic powder, relative permittivity of the first bonded magnet being greater than 40 and equal to or less than 200;
an inner rotor;
a plurality of ribs extending in a radial direction and connecting the outer rotor and the inner rotor;
a shaft supporting the inner rotor;
a first bearing supporting an end portion of the shaft on a load side; and
a second bearing supporting an end portion of the shaft on an anti-load side,
wherein the inner rotor and the plurality of ribs are formed of a second bonded magnet, and
the rotor satisfies b×L1/(a×N×L2)≥0.3 and a×N/(D×π)≤0.8,
where L1 is a length in an axial direction of the outer rotor, L2 is a length in the axial direction of the rib, D is a diameter of the inner rotor, N is the number of the ribs, a is a width, in a circumferential direction of the rotor, of each of the ribs, and b is a length in the radial direction of the rib.

2. (canceled)

3. The rotor according to claim 1, wherein the second bonded magnet is the same material as the first bonded magnet.

4. (canceled)

5. A rotor comprising:
an outer rotor formed of a first bonded magnet, the first bonded magnet being a complex containing first resin and magnetic powder, relative permittivity of the first bonded magnet being greater than 40 and equal to or less than 200;
an inner rotor;
a plurality of ribs extending in a radial direction and connecting the outer rotor and the inner rotor;
a shaft supporting the inner rotor;
a first bearing supporting an end portion of the shaft on a load side; and
a second bearing supporting an end portion of the shaft on an anti-load side,
wherein the inner rotor and the plurality of ribs are formed of a second resin having relative permittivity lower than relative permittivity of the first bonded magnet forming the outer rotor,
the rotor satisfies b×L1/(a×N×L2)≥0.03 and a×N/(D×π)≤1.0,
where L1 is a length in an axial direction of the outer rotor, L2 is a length in the axial direction of the rib, D is a diameter of the inner rotor, N is the number of the ribs, a is a width, in a circumferential direction of the rotor, of each of the ribs, and b is a length in the radial direction of the rib.

6. (canceled)

7. The rotor according to claim 1, wherein the magnetic powder contains ferrite.

8. The rotor according to claim 1, wherein the first resin contains at least one of polyamide resin or polyphenylene sulfide resin.

9. (canceled)

10. An electric motor comprising:
the rotor according to claim 1;
a stator; and
a housing that houses the rotor and the stator.

11. The electric motor according to claim 10, wherein the stator, a first outer ring of the first bearing, and a second outer ring of the second bearing are in electrical contact with the housing.

12. A blower comprising:
the electric motor according to claim 10; and
a blade to be driven by the electric motor.

13. A ventilator comprising the electric motor according to claim 10.

14. An electrical machine comprising the electric motor according to claim 10.

15. An air conditioner comprising:
an indoor unit; and
an outdoor unit to be connected to the indoor unit,
wherein at least one of the indoor unit or the outdoor unit includes the electric motor according to claim 10.

16. The rotor according to claim 5, wherein the magnetic powder contains ferrite.

17. The rotor according to claim 5, wherein the first resin contains at least one of polyamide resin or polyphenylene sulfide resin.

18. An electric motor comprising:
the rotor according to claim 5;
a stator; and
a housing that houses the rotor and the stator.

19. The electric motor according to claim 18, wherein the stator, a first outer ring of the first bearing, and a second outer ring of the second bearing are in electrical contact with the housing.

20. A blower comprising:
the electric motor according to claim 18; and
a blade to be driven by the electric motor.

21. A ventilator comprising the electric motor according to claim 18.

22. An electrical machine comprising the electric motor according to claim 18.

23. An air conditioner comprising:
an indoor unit; and
an outdoor unit to be connected to the indoor unit,
wherein at least one of the indoor unit or the outdoor unit includes the electric motor according to claim 18.
